(19) United States
(12) Patent Application Publication
(10) Pub. No.: US 2009/0011945 A1
(43) Pub. Date: Jan. 8, 2009

(54) Method For Making Microsensor Arrays For Detecting Analytes

(76) Inventors: Frank V. Bright, Williamsville, NY (US); Eun Jeong Cho, Austin, TX (US)

Correspondence Address: HODGSON RUSS LLP;THE GUARANTY BUILDING, 140 PEARL STREET, SUITE 100, BUFFALO, NY, 14202-4040, US

(21) Appl. No.: 11/957,915

(22) Filed: Dec. 17, 2007

Related U.S. Application Data
(63) Continuation-in-part of application No. 10/351,109, filed on Jan. 24, 2003, now abandoned.
Application No. 10/351,109 is a continuation-in-part of application No. 10/254,254, filed on Sep. 25, 2002, now Pat. No. 6,589,438.
Application No. 10/254,254 is a division of application No. 09/628,209, filed on Jul. 28, 2000, now Pat. No. 6,492,182.
(60) Provisional application No. 60/351,592, filed on Jan. 25, 2002.
(60) Provisional application No. 60/145,856, filed on Jul. 28, 1999.

(51) Int. Cl. C40B 30/00

(52) U.S. Cl. 506/7

(57) ABSTRACT

The present invention provides a method and a device for high-throughput, simultaneous, and continuous detection of one or more analytes using a pin-printed chemical sensor array. Chemical sensors comprising [Ru(4,7-diphenyl-1,10-phenanthroline)₃]²⁺, glucose oxidase, and fluorescein sequestered in sol-gel-derived-glass have been used. Examples of analytes detected using the present method include O₂, glucose, and protons. Gas-phase and liquid-phase analytes have been detected using the present method. In addition, analytes contained in an aerosol have been detected.

This application is a continuation in part of U.S. patent application Ser. No. 10/351,109 filed Jan. 24, 2003, which claims priority to U.S. provisional patent application Ser. No. 60/351,592 filed on Jan. 25, 2002; and which is also a continuation in part of U.S. patent application Ser. No. 10/254,254 filed Sep. 25, 2002, now U.S. Pat. No. 6,589,438; which in turn is a divisional application of U.S. patent application Ser. No. 09/628,209 filed Jul. 28, 2000, now U.S. Pat. No. 6,492,182, which in turn claims priority to U.S. provisional patent application No. 60/145,856 filed on Jul. 28, 1999. The disclosures of all of the above are incorporated herein by reference.

This invention was made with Government support under Grant Number CHE0078161 awarded by the National Science Foundation. The Government has certain rights in the invention.

### FIELD OF THE INVENTION

The present invention relates to the field of detection of analytes using chemical sensors. More particularly, the present invention provides a method for high-throughput, continuous detection of analytes using chemical sensors.

### BACKGROUND OF THE INVENTION

Chemical detection is widely used in clinical diagnosis and biomedical research to selectively detect the presence of a particular analyte or ensemble of analytes, or to measure other characteristics of samples, such as pH. These measurements are based on the principle that interaction of an analyte within a sample with a specific detector results in modification of properties of the detector to a degree that depends on the concentration of the analyte.

In the case of chemical sensors, spectroscopic properties of the sensors are modified in the presence of analytes. Modification of spectroscopic properties may involve changes in the intensity, wavelength, phase, or polarization of incident electromagnetic radiation (ER). For example, fluorophores are molecules which absorb light at certain wavelengths and emit light of a different wavelength (generally longer). In the presence of an analyte, the optical properties of some fluorophores are altered and this forms the basis for optical detection and quantitation of analytes using fluorophores.

Chemically responsive sensor arrays can be subdivided into those that use cantilevers, conducting polymers, electrochemistry, the piezoelectric effect, physical optics, or surface acoustic waves. To date, sensor arrays have been fabricated using a number of approaches including, ink-jet and screen printing, photolithography, and photodeposition. However, reusable multi-analyte chemical sensor arrays are not yet available.

When an analyte binds to a detector such that the binding is irreversible unless there is a change in the environment (e.g. temperature, pressure, solvent, salt concentration, etc.), the detector cannot be used to continuously detect the analyte. This is problematic in that the detector must be reconditioned, i.e. the analyte must be disengaged from the detector before the detector is again useful for detecting an analyte. Therefore, there is a need for developing methods that enable real-time use of a detector without reconditioning, allowing continuous analyte detection without bias.

### SUMMARY OF THE INVENTION

The present invention provides a method and a device for high-throughput, simultaneous, and continuous detection of one or more analytes using a pin-printed chemical sensor array. The method comprises of the steps of: i.) providing a device, where the device comprises a substrate; an array of pin-printed spots on the substrate having a chemical sensor sequestered in a sol-gel-derived glass; and a detector for continuously recording the emitted signal from each pin-printed spot; ii.) contacting the array with samples containing one or more analytes; iii.) irradiating the array with electromagnetic radiation of 200 to 900 nm; and iv.) detecting the signal from each pin-printed spot as a function of time.

In one embodiment, the sol-gel-derived glass is a xerogel. In another embodiment, the sol-gel-derived glass is doped with a polymer such as polyethylene glycol or Pluronic P104. The electromagnetic generator for irradiating the array may be integrated within the device. In one embodiment the electromagnetic generator is a light-emitting diode which also serves as the substrate for pin-printing the chemical sensor array.

In the present invention chemical sensors are used to detect an analyte. Chemical sensors are a molecule, molecules, or materials whose optical properties are modified in the presence of an analyte. The interaction between the chemical sensor and the element is reversible such that the chemical sensor can continuously detect the presence of or change in concentration of the analyte within the sample. The analyte can be continuously detected without changing the physical environment of the sensor, e.g. temperature, pressure, or nature of the solvent system. Suitable examples of chemical sensors include a transition-metal compound (e.g. [Ru(4,7-diphenyl-1,10-phenanthroline)₃]²⁺), a macromolecule linked to organic fluorophores (e.g. fluorescein-labeled dextran), and enzymes (e.g. glucose oxidase).

In the present invention fluid-phase analytes, such as analytes in solution and analytes contained in an aerosol have been detected. Fluid-phase analytes include gas-phase analytes and liquid-phase analytes. For example, O₂ in the gas-phase, O₂, in solution, glucose in solution, glucose contained in an aerosol and protons in solution have been detected.

### BRIEF DESCRIPTION OF THE DRAWINGS

FIG. 1 is a schematic representation of a general configuration for detecting the ER emitted by a chemical sensor prepared according to the invention herein.

FIG. 2 is a schematic representation of the processes for forming pin-printed optical sensor array and integrated light source (PPOSAILS) type chemical sensor arrays.

FIG. 3 is a simplified schematic representation describing the formation of four types of biosensor arrays.

FIGS. 4 A-D summarizes the response from a series of tailored O₂- and pH-responsive sensor elements within a dual-analyte pin-printed chemical sensor array (PPCSA) prepared according to Example 2.

### DETAILED DESCRIPTION OF THE INVENTION

The present invention provides a method and a device for high-throughput, simultaneous, and continuous detection of one or more analytes using a PPCSA. The high-throughput, continuous detection is achieved by using chemical sensors sequestered in a holding material in pin-printed spots on a substrate such that continuous and reproducible detection of analytes can be carried out. Using the format of the present invention, a single analyte can be detected in multiple samples or locations (corresponding to the different pin-printed spots) in a continuous manner over a defined time period. This device can also be used for detecting multiple analytes in a single sample or multiple samples or locations in a continuous manner over a defined time period. The device comprises an array of pin-printed spots, each spot containing one or more molecules of a chemical sensor. All the spots in an array may contain the same chemical sensor or different spots in the array may contain different chemical sensors.

The term “chemical sensor” or “chemical sensors” as used herein means a molecule, molecules, or material that detect(s) the presence of an analyte in a continuous and reversible manner. The “chemical sensor” comprises a molecule, molecules, or material whose optical properties are modified in the presence of an analyte. The properties of the chemical sensor may be directly modified upon interaction of the chemical sensor with the analyte. This interaction is reversible, i.e. the concentration of analyte can be continuously detected as the concentration within the samples increases or decreases without changing the physical environment of the sensor (e.g. temperature, pressure, or nature of the solvent system). Thus, real-time measurements of analyte concentration changes can be carried out. This is to be contrasted with devices wherein high affinity binding occurs, but the nature of the interaction or of the platform is kinetically and thermodynamically irreversible (e.g., DNA microarrays and the like).

Chemical sensors that are useful for the present invention include materials whose spectroscopic properties are modified due to reversible interaction with specific analytes. The modification of spectroscopic properties may include a change in wavelength, intensity, phase, and/or polarization of the incident electromagnetic radiation (ER).

Materials or molecules that absorb ER and as a result of that electronic absorption emit ER of a different wavelength from the one absorbed are fluorescent or phosphorescent. The absorption and emission spectra are characteristic for each fluorophore or phosphore. Many fluorescent/phosphorescent dyes are known in the art that absorb ER of a specific wavelength and that are sensitive to one or more analytes. Chemical sensors that can be used in the practice of the present invention include ER absorbing and ER emitting inorganic or organic dyes (either natural, synthetic, or combinations thereof). Such dyes include phosphores and fluorophores. Many luminescent molecules are well known to those skilled in the art. Examples of such materials are disclosed in U.S. Pat. No. 5,250,264. Other sources of useful chemical sensors include the Handbook of Fluorescent Probes and Research Chemicals, 6th ed., authored by Richard P. Haugland and published by Molecular Probes, Inc. of Eugene, Oreg.

A macromolecule can be used as a carrier for a fluorophore. In one embodiment, dextran, a sugar-based macromolecule, is used as a carrier for fluorescein.

As examples, we have sequestered particular transition metal compounds, proteins, and organic fluorophores within a holding material in the pin-printed spots. In one embodiment, the chemical sensor is [Ru(dpp)₃]²⁺, a transition-metal containing compound. In another embodiment, the chemical sensor is glucose oxidase, a protein (enzyme). In yet another embodiment, the chemical sensor is fluorescein, an organic fluorophore, linked to dextran.

Typically, ER capable of exciting and/or populating upper electronic transitions in a molecule or material fall within a wavelength region of 200 nm to 900 nm, which includes ultraviolet, visible and infrared portions of the electromagnetic spectrum. The properties of the chemical sensor are optical in nature when the emitted ER falls within the visible spectrum, i.e. between about 400 nm to about 800 nm. It is also possible to use non-linear, multi-photon strategies to excite fluorescence and phosphorescence using excitation above 900 nm.

As discussed above, some of the chemical sensor elements absorb light emitted from a light-emitting device (LED) or other light source in the presence of an analyte to a degree that depends on the analyte concentration, while others luminesce in the presence of the analyte to be detected and/or quantified to a degree that depends on the analyte concentration.

Examples of the types of analytes which can be detected using the present method include CO₂, O₂, pesticides, drugs, herbicides, anions, cations, antigens, oligonucleotides, steroids, prostaglandins, and haptens. Potential analytes also include any organic molecules such as polycyclic aromatic hydrocarbons, explosives, glucose, cholesterol, amino acids, peptides, DNA and RNA. Further, the chemical sensor array device prepared according to the method of the present invention can indicate the pH of a sample via the detection of protons, i.e. hydrogen ions. There are many more substances which can be detected, and the foregoing list is not to be considered exhaustive, but instead merely representative.

Analytes detected by the present invention can be present in the fluid phase (i.e., gas-phase or liquid phase) and in solution. Analytes can also be detected when present in the form of an aerosol. The holding materials of the pin-printed spots needs to be such that the analytes can diffuse through it and reach the chemical sensors in a reproducible manner. It was observed that by using sol-gel-derived glass as the holding material, analytes in the gas phase as well as in solution could be detected. In one embodiment, O₂ in the gas phase is detected. In another embodiment, O₂ in solution is detected. In another embodiment, glucose in solution is detected. In another embodiment, protons in solution are detected. In another embodiment, glucose in the form of an aerosol is detected.

The association of analytes with the pin-printed chemical sensors is reversible. The term “reversible” or “reversibility” as used herein refers to the ability of the chemical sensor to detect the presence of an analyte within a sample in a continuous manner as the sample concentration within the sample increases and decreases and to do so in an unbiased manner. The presence of the analyte is identified by detecting a signal that is indicative of the analyte concentration. The absence of the analyte can be identified by a lack of a detectable signal or a signal that is not significantly different than the background signal. Upon re-exposure to the analyte, the signal can again be recorded.

For example, in one embodiment of the present invention, when a chemical sensor pin printed on a substrate of an LED was exposed to a sample containing 100% O₂, a stable signal was detected in less than a minute. When the sample was switched to 100% N₂, a substantially baseline signal was reached in less than a minute and when the sensor was again exposed to 100% O₂, a signal of substantially the same intensity (at least 98%) as the first signal was reached in less within a minute. In various embodiments, the signal observed on re-exposure of the chemical sensor to O₂ was 90, 91, 92, 93, 94, 95, 96, 97, or 98% of the first signal. This behavior holds true for any O₂/N₂ concentration ratio. It should be noted that for the reversibility, no changes in the physical parameters, such as temperature or pressure, describing the environment of the chemical sensor are required. Only the analyte concentration changes. Thus, this reversibility is distinct from the annealing and denaturation which occurs in nucleic acid hybridization assays upon adjustment of temperature or change in salt concentration of the solvent system.

Any change over time in the concentration of the analyte in the immediate environment of the sensor results in a signal from the sensor that is readily correlated to the analyte concentration in the sample at the point in time of the signal measurement. The signal is also an accurate and precise measure of the analyte concentration at that specific point in time. The reversible nature of the interaction between the sensor and the analyte allows detection of an analyte in a continuous manner and no change in temperature or pressure or other means (e.g., pH swing, chaotrope, denaturant) is required to disengage/dissociate the analyte from the sensor. We have successfully use the present method for reversibly and continuously detecting analytes over a period of several months. For example, the signal from the chemical sensor was continuously detected over a period of at least one year with minimal drift (relative standard deviation ≦5%).

It was observed that the chemical sensors sequestered in holding materials in the pin-printed spots produce reproducible results with very little sensor-to-sensor variability (typically ≦5% relative standard deviation). Typically, a response time of less than a minute, preferably less than 30 seconds and more preferably less than 15 seconds is observed. In one embodiment, the response time is 5-12 seconds. In another embodiment, the response time is 10 seconds. The response time depends on the thickness of the pin-printed spot, the partition characteristics of the analyte, and the analyte diffusion coefficient. Typically, the response time for a gaseous analyte is faster than that for the same analyte in solution. This difference in relative response times between gaseous analytes and analytes in solution is due in large part to the larger diffusion coefficient in the gas phase which is generally observed for gaseous analytes relative to analytes dissolved in solution.

In one embodiment of the invention, simultaneous detection of multiple analytes can be carried out by the same array by pin-printing spots containing different chemical sensors. For example, an array may contain pin-printed spots having O₂ sensors as well as other spots having a pH sensor. It was observed that in this format, there was no significant interference in the detection of one analyte due to the presence of the other.

The present method for detecting analytes, wherein the interaction between the analyte and chemical sensor is reversible, permits continuous detection of analytes and also permits reuse of the same chemical sensor array for analysis of multiple samples without any intervening reconditioning. The present method can be useful in wide-ranging applications such as monitoring cell cultures, determining reagent and product concentrations during chemical production processes, monitoring drug interactions with patients, and localizing pollutant concentrations, where real-time detection of analytes is important. For example, in monitoring the environment of stem-cell cultures, the real-time detection of analytes can be critical in following and manipulating differentiation of the cells.

The detection of the transmitted or emitted ER from the chemical sensor array device may be carried out by collecting the ER from each individual pin-printed spot with an objective, passing it through an optical filter system that blocks the excitation ER and ultimately communicating to a solid state array detector, such as a charge coupled device (CCD) or complementary metal oxide semi-conductor (CMOS).

A chemical sensor device prepared according to the following can be used according to the present method for continuous detection and quantification of one or more analytes in a sample. Where a sample contains multiple analytes, the method described herein can be used to continuously detect multiple analytes simultaneously.

The expression “pin-printed chemical sensor array” (PPCSA) as utilized herein means a device comprised of an array of pin-printed spots contact printed onto a planar substrate in an array pattern wherein the pin-printed spot, comprising a chemical sensor within a holding material, is excited with a light source.

The expression “pin-printed optical sensor array and integrated light source” (PPOSAILS) as utilized herein means a device comprising an array of pin-printed spots contact printed onto an ER generating substrate such as the face of an LED.

The expression “pin-printed biosensor arrays” (PPBSA) as utilized herein means a device comprised of an array of pin-printed spots, wherein the pin-printed spots are comprised of immobilized biomolecule sensors, contact printed onto a planar substrate. The PPBSA may also be used along with other chemical sensors in a PPCSA or a PPOSAILS pin-printed spot device.

A device suitable for practicing the current invention comprises a substrate transparent or translucent to ER. Examples of suitable substrates for use in certain embodiments of the invention herein would include glass or quartz microscope slides, polymeric microscope slides, polymeric coated glass or quartz microscope slides, cover slips for microscope slides, optical filters, mirrored slides, optical array detectors (e.g., charge coupled device detectors). The substrate can be an ER generator. The ER generated by the generator is such that at least some of it can be absorbed by a phosphore or fluorophore of the chemical sensor. To be absorbed by the luminophore (fluorophore or phosphore) requires that the wavelength range output from the generator overlap at least partially with one or more allowed electronic transitions within the chemical sensor.

A useful substrate is preferably transparent or translucent for at least some wavelengths of from about 300 nm to about 900 nm. Translucent substrate materials preferably have a transmittance of 50% or greater. Examples of substrate materials would include standard glass microscope slides such as those distributed by Fisher Laboratory Products of Pittsburgh, Pa. Polymeric substrates or polymeric coated substrates would also be suitable in the practice of the method described herein. Optionally, an optical filter can be used as a substrate. ER generating substrates can also be used. An example of an ER generating substrate is an LED such as those distributed by Nichia America Corporation of Mountville, Pa. LEDs can be machined to remove the domelike portion of the protective envelope to form a planer surface. Optionally, a LED formed without the rounded envelope may be used as the substrate.

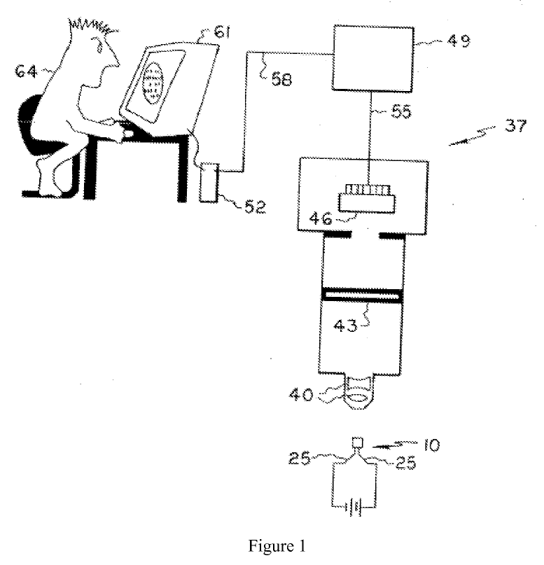

The ER emitted by the chemical sensor may be detected by any suitable method known in the art. A general configuration of a system able to detect the presence of analytes using the present method is illustrated in FIG. 1, which shows a detecting device 10 prepared according to Examples 4, 6, 9 in combination with a receiving and interpreting system 37. The receiving and interpreting system 37 has a receiver to receive ER transmitted or emitted by the chemical sensor and an interpreter to interpret the received radiation. The receiver shown in FIG. 1 includes a lens or series of lenses 40, a filter or series of filters 43 and a receiving surface 46. A suitable receiver is a microscope objective. The receiver may have a camera for recording images. The interpreter includes a controller 49 and a computer 52 having software running thereon. The receiving surface 46 is connected to the controller 49 via first communication line 55. The controller 49 is connected to the computer via second line 58.

An example of a device having a series of lenses 40, is a standard inverted fluorescence microscope. An example of a microscope suitable for use in the present invention is, model number BX-FLA available from Olympus America, Inc. of Melville, N.Y.

The receiving surface 46 may be a charge coupled device, which may be part of a CCD camera. Any other optical array detector will also suffice. An example of a CCD camera which can be used in the present invention is model number TE/CCD-1317K manufactured by Princeton Instruments, Inc. of Trenton, N.J. An example of a controller 49 which is suitable for use in the present invention is model number ST-138 manufactured by Princeton Instruments.

A filter 43 may be placed between the detecting device 10 and the receiving surface 46. The filter 43 selectively passes desired wavelengths of the ER moving from the detecting device 10 toward the receiving surface 46 and blocks undesired wavelengths. An example of a filter 43 which can be used to practice the present invention is model number XF 3000-38 manufactured by Omega Optical of Brattleboro, Vt. This particular filter passes ER above approximately 515 nm and strongly attenuates ER below approximately 515 nm. Other filters or filter combinations are possible depending on the generator wavelength and the particulars associated with a given sensor.

The ER generator can be any means for generating ER of a wavelength that will cause electronic transitions in a chemical sensor such as light emitting diodes, diode lasers and micro discharge devices such as those disclosed in U.S. Pat. Nos. 6,016,027, 6,139,384 and 6,194,833. In a preferred embodiment, the ER generator is a light emitting diode (LED). When an LED is used as the ER generating substrate it can be an LED that is formed with a planar surface or may be an LED that has been machined to remove a portion of its protective envelope to provide a planar surface. Depending upon the composition of the substrate, it may be necessary to apply a buffer layer to the substrate prior to beginning pin printing. Any suitable material that is at least translucent may be used as the buffer layer. A suitable material for forming the buffer layer will be one that is able to adhere to the substrate and allows the pin-printed spots to adhere to it. Examples of suitable materials for forming a buffer layer would include sol-gel-solutions, pigmented sol-gel solutions, tinted sol-gel solutions, paint, polymers, etc. When the substrate is a machined LED or some other substrate with an irregular surface, it may be necessary to form a buffer layer to provide a uniform surface prior to pin printing. When the substrate is a uniform surface and adhesion of the pin-printed spots to the substrate is adequate, it may not be necessary to use a buffer layer. In applications where it is desirable to limit the wavelength of light reaching the pin-printed spot, the buffer layer may comprise a filtering coating selected to be transmissive for the peak wavelength of the ER generating substrate. Buffer layers may be applied to the substrate by any suitable method, for example, spraying, coating, spin-coating, casting, vapor deposition, et cetera.

The pin-printed spot can be placed directly on the substrate. There are a number of commonly recognized methods of fabricating chemical sensors on a substrate including, but not limited to: ink-jet printing, screen printing, photolithography, and photodeposition. Pin printing is also a means by which a chemical sensor can be fabricated. The number, size, and shape of the pin-printed spot element placed on a substrate can vary. While any ratio of pin-printed spot area to non pin-printed spot is suitable, a ratio of 1:1 generally ensures that individual pin-printed spots are reasonably well separated from one another. For example, on an LED of 5 mm diameter, having 100 μm diameter pin-printed spots, with a 1:1 ratio of sensor element area to non sensor element area, it is estimated that 1200 discrete pin-printed spots can be formed on the LED face. Each pin-printed spot may contain the same or different chemical sensor so that the same LED may be used for the simultaneous detection and quantitation of a single or multiple analytes.

To form the pin-printed spot, a holding material is preferably used. Any liquid material known to those skilled in the art for holding, immobilizing, entrapping, and/or sequestering chemical sensors, can be used. These materials include, but are not limited to, sol-gel precursors, xerogels, aerogels, protein-doped xerogels, acrylamide gels, organic polymers, inorganic polymers, molecularly imprinted materials, and mixtures thereof. One commonly used holding material is a sol-gel-derived glass. A sol-gel-derived glass is a porous glass formed by the condensation and polycondensation of one or more metal or semi-metal alkoxide mixtures. Sol-gel-derived glasses provide a convenient means to sequester sensors, and/or sensing agents, because they prevent leaching from the holding material, and the glasses themselves are porous, thereby allowing analytes to penetrate into the glass, and react with the chemical sensors. Sol-gel processed xerogels are also useful for holding protein based chemical sensors. It is known that protein-doped xerogels demonstrate k_{cat}, kₘ or K_{binding} for biomolecules within the xerogels that are substantially unchanged from the values in solution and the xerogel-doped biomolecules remain stable for relatively long periods of time. It is also known that xerogels can be molecularly imprinted. Glasses with surface areas of up to several hundred square meters per gram and narrow pore diameters (0.5 to 500 nm) are readily prepared using sol-gel methods well known to those skilled in the art of sol-gel processing chemistry. A detailed discussion of sol-gel chemistry can be found in Reisfeld et al., 1992, Chemistry, Spectroscopy and Application of Sol-Gel glasses, Springer-Verlag, Berlin; Brinker et al., 1989, Sol-Gel Science, Academic Press, New York; Dave et al., 1994, Anal. Chem. 66:1120 A, 1121A. It is preferred that the mean pore diameter be less than the mean wavelength of ER from the generator, but deviation leads only to a predictable decrease in performance. The sol-gel-derived glass useful in the present invention is preferably transparent or translucent for wavelengths of from about 300 nm to about 900 nm. Translucent materials preferably have a transmittance of 50% or greater.

Chemical sensors may simply be added to the sol-gel-derived glass holding material once the sol-gel-derived glass is placed or located or formed on the substrate, or they may be doped into the sol-gel processing solution (precursor to the glass and/or xerogel) to provide a pin-printed spot solution before it is placed onto the substrate. A property which makes sol-gel-processed materials useful for the present invention is that molecules sequestered within the glass may interact with diffusible analytes or components in an adjacent liquid or gas phase within the glass pore space. In addition to sol-gel-derived glass, other organic or inorganic polymers and mixtures thereof that can be pin printed onto the substrate and remain on the substrate, can also be used as holding materials.

Making a sensor device array according to the invention herein involves pin printing a small volume of chemical sensor and/or holding material onto the substrate. Methods of pin printing are well known by those skilled in the art. A description of suitable pin printing methods may be found in Mark Schena, ed., Microarray Biochip Technology Eaton Publishing, Westborough, Mass.

Pin printing involves direct contact between the printing mechanism and the substrate. Although pin printing may be performed manually, to obtain improved results, use is frequently made of electro-mechanical pin printing devices such as the ProSys 5510 System available from Cartesian Technologies, Inc. of Irvine, Calif.

In pin printing, pin tools are dipped into the chemical sensor and/or holding material, resulting in the transfer of a small volume of fluid onto and/or within the tip of the pins. Pin tools deliver sample spots of chemical sensor and/or holding material onto the substrate and include solid pins, capillary tubes, tweezers, split pins and micro-spotting pins or “ink stamps”. Touching the pins or pin samples onto the substrate leaves a spot, the diameter of which is determined by the surface energies of the pin, fluid, and substrate; and the pin velocity. The pins typically have a loading volume of about 0.2 to about 0.6 μL and can produce spots ranging from about 600 to about 100 μm in diameter, depending on printing solution surface properties.

The final pin-printed spot dimensions are a function of the pin dimensions; the sol-gel-processing solution composition, hydrolysis time, and mixing method (stirring vs. sonication); the relative humidity during printing; the pin velocity toward the substrate and contact time with the substrate; and the surface chemistry of the substrate. For example, individual xerogel-based pin-printed spots on the order of 100-150 μm in diameter and 1-2 μm in average thickness can be provided by certain embodiments of the invention herein. Selection of an appropriate final pin-printed spot dimensions is within the purview of one skilled in the art.

Efficient cleaning of the pins during the printing process is recommendable to prevent solution carryover which would complicate any multianalyte sensing strategy. The pins may be cleaned by dipping the pins into ethanol or other suitable wash liquid and then removing the wash liquids from the pins with a vacuum. In cases where more rigorous cleaning is necessary, one can use acid (e.g., HCl) or base (e.g., NaOH) solutions.

The following examples are presented for illustrative purposes and are not to be construed as limiting and in which the following abbreviations are used to describe certain substances: TEOS is tetraethoxysilane available from United Chemical Technologies of Bristol, Pa. Pro-TriMOS is n-propyltrimethoxysilane available from Hüls America of Somerset, N.J. TMOS is tetramethoxysilane available from United Chemical Technologies of Bristol, Pa. [Ru (dpp)₃]²⁺ is tris(4,7-diphenyl-1,10-phenanthroline) ruthenium (II) ion, purified from the chloride pentahydrate salt available from GFS Chemicals of Powell, Ohio. GOx is glucose oxidase type VII-S from Aspergillus niger (100-200 units mg-1) available from Sigma-Aldrich of St. Louis, Mo. PBS is phosphate buffered saline (pH 7.4).

### EXAMPLE 1

This example illustrates the reversibility of the interaction between analytes and chemical sensors used to detect analytes in the present method and therefore, the suitability of the present method for the continuous detection of analytes.

The response time data in Table 1 demonstrates the reversibility of the interaction between a gas-phase analyte (O₂) and O₂-responsive PPCSAs (fabricated according to Example 4).

TABLE 1
Pooled analytical figures of merit for a gas-phase O₂-responsive PPCSA.

| Analytical Figure of Merit | Value |
|---|---|
| Response time^{a} | 10 ± 1 s |
| Detection limit | 0.05% O₂ |
| Absolute spot-to-spot response reproducibility | 5% |
| Short-term pin-printed spot stability^{a,c} | 3% |
| Long-term single pin-printed spot stability^{a,d} | 6% |
| Absolute PPCSA-to-PPCSA response | 11% |
| reproducibility^{a,e} | |

^{a}Average of 100 pin-printed spots on a single PPCSA ± the standard deviation.
^{b}Based on the analysis of the calibration curve of each PPCSA pin-printed spot.
^{c}After 3 hrs of continuous operation in a 10% O₂ environment. Laser stability is ~2% RSD.
^{d}Full shut down, disassemble, weekly single-pin-printed spot recalibration and reuse of a single PPCSA for 10 weeks.
^{e}Based on the response profiles of eight (8) separate PPSCAs fabricated at one week intervals over the course of 2 months using separate reagent batches and preparations following a single-point calibration.

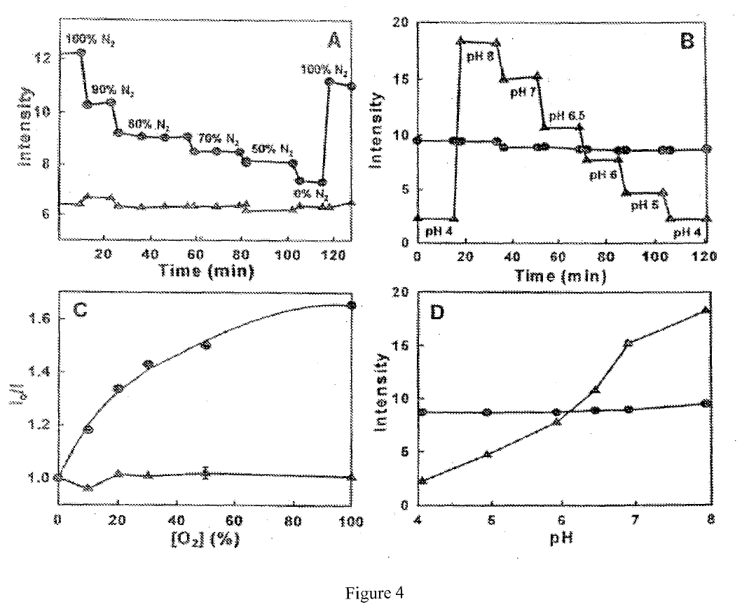

FIGS. 4 A-D summarizes the response from a series of O₂— () and pH-responsive (▴) pin-printed spots within a dual-analyte PPCSA (fabricated according to Example 3) to changes in solution O₂ and pH levels. FIG. 4A shows the raw response profiles from O₂ and pH pin-printed spot as a function of changes in the aqueous O₂ levels in distilled-deionized water. Inspection of these results shows that the O₂ pin-printed spots respond in step with changes in the O₂ level and the pH pin-printed spot response is not affected by changes in the O₂ level. FIG. 4B shows the raw response profiles from O₂ and pH pin-printed spot as a function of changes in the aqueous buffer pH when the solution is air saturated. These results demonstrate that the pH pin-printed spots respond only to changes in the pH and the O₂ pin-printed spots response is not affected by changes in the solution pH. FIGS. 4C and 4D represent the corresponding O₂ and pH calibration curves from the data in FIGS. 4A and 4B, respectively. No significant pin-printed spot-to-pin-printed spot cross talk or interference is observed. Table 2 summarizes the analytical performance of the dual-analyte PPCSA (fabricated according to Example 3). These results show the effectiveness of the method described herein for simultaneous multi-analyte quantification.

TABLE 2
Pooled analytical figures of merit for the dual-analyte PPCSA in
aqueous solution.

| | O₂ Pin- | pH Pin- |
|---|---|---|
| Analytical Figure of Merit | Printed Spot | Printed Spot |
| Response time^{a} | 38 ± 18 s | 47 ± 8 s |
| Detection limits^{b} | 0.1% | NA |
| Resolution^{c} | NA | 0.12 pH units |
| Reversibility^{d} | 3% | 5% |
| Absolute spot-to-spot response | 6% | 7% |
| reproducibility | | |
| Short-term single pin-printed spot | 4% | 4% |
| element stability | | |
| Long-term single pin-printed spot | 8% | 6% |
| element stability^{a,g} | | |
| Absolute PPCSA-to-PPCSA response | 12% | 10% |
| reproducibility^{a,h} | | |

^{a}Average of 30 pin-printed spot on a single PPCSA ± the standard deviation. The average of a switch between 100% O₂ and 100% N₂ or pH 4.5 and 7.5. Time is defined as the average time required to reach 90% of the full response.
^{b}Minimum quantity of O₂ that can be detected.
^{c}pH resolution at pH 6.5.
^{d}Results of 25 cycles between 100% O₂, and 100% N₂ or pH 4.0 and 8.0.
^{e}Based on the analysis of the calibration curve of each PPCSA pin-printed spot.
^{f}After 3 hrs of continuous operation in air-saturated buffer at pH 6.52. Laser stability is ~2% RSD.
^{g}Full shut down, disassembly, weekly, single-pin-printed spot element recalibration, and reuse of a single PPCSA for 6 weeks.
^{h}Based on the response profiles of five (5) separate PPSCA fabricated at two-three week intervals over the course of 2.5 months using separate reagent batches and preparations following a single-point calibration.
NA—not applicable.

The response time data in Table 3 demonstrates the reversibility of the interaction between an analyte and a pin-printed spot of a PPOSAILS device.

TABLE 3
Pooled analytical figures of merit for an O₂-responsive PPOSAILS.

| Analytical Figure of Merit | Value |
|---|---|
| Response time^{a} | 7 ± 2 s |
| Detection limit | 0.05% O₂ |
| Absolute spot-to-spot response reproducibility | 2% |
| Short-term single pin-printed spot stability^{a,c} | 4% |
| Long-term single pin-printed spot stability^{a,d} | 6% |
| PPOSAILS-to-PPOSAILS fabrication | 8% |
| reproducibility^{a,c} | |

^{a}Average of 100 pin-printed spots on a single PPOSAILS ± the standard deviation.
^{b}Based on the analysis of 100 PPOSAILS pin-printed spot calibration curves.
^{c}After 12 hrs of continuous operation in a constantly cycled (100, 0, and 10% O₂) environment. The LED optical output is stable to ± 3%.
^{d}Full shut down, weekly, single-pin-printed spot recalibration, and reuse of a single PPOSAILS for 8 weeks.
^{e}Based on the calibration curves for 100 pin-printed spots on eight (8) separate PPOSAILS fabricated at one week intervals over the course of 8 weeks using separate reagent batches and preparations following a single-point calibration.

The response time data in Table 4 demonstrates the reversibility of the interaction between analytes (glucose, O₂) and the pin-printed spots of PPBSAs (fabricated according to Example 9).

TABLE 4
Pooled analytical figures of merit for PPBSAs responding to glucose and O₂^{a}.

| | | | | | response reproducibility | | |
|---|---|---|---|---|---|---|---|
| | | | | | (%) | | |
| array | response | detection | | | short- | long- | PPBSA-to- |
| format | time (s)^{b} | limits^{c} | response^{d} | reversibility^{e} (%) | term^{f} | term^{g} | PPBSA^{h} |

PPBSA 1

| | | | | | | | |
|---|---|---|---|---|---|---|---|
| glucose | 47 ± 17 | 0.1 mM | 29 ± 2% | 6 | 3 | 7 | 12 |
| O₂ | 12 ± 1 | 0.1% | 3.2 ± 0.1 | 5 | 4 | 4 | 10 |

PPBSA 2

| | | | | | | | |
|---|---|---|---|---|---|---|---|
| glucose | 34 ± 8 | 0.1 mM | 35 ± 3% | 5 | 3 | 8 | 12 |
| O₂ | 12 ± 2 | 0.1% | 3.5 ± 0.1 | 5 | 3 | 6 | 11 |

PPBSA 3

| | | | | | | | |
|---|---|---|---|---|---|---|---|
| glucose | 48 ± 14 | 0.2 mM | 17 ± 2% | 7 | 5 | 7 | 10 |
| O₂ | 10 ± 2 | 0.1% | 3.1 ± 0.1 | 5 | 4 | 5% | 9 |

PPBSA 4

| | | | | | | | |
|---|---|---|---|---|---|---|---|
| glucose | 35 ± 7 | 0.2 mM | 25 ± 3% | 5 | 3 | 6 | 8 |
| O₂ | 12 ± 3 | 0.1% | 3.4 ± 0.2 | 5 | 4 | 5 | 10 |

^{a}For 100 pin-printed spots on a single PPBSA.
^{b}Based on the time required to reach 90% of the full response following a switch between air-saturated buffer that contained 10 mM glucose and air-saturated buffer alone without glucose or O₂- and N₂-saturated buffer solution. Laser stability ~2% RSD.
^{c}Minimum quantity of glucose or O₂ that can be detected.
^{d}Defined as (I − I0)/I0 × 100% at 4 mM glucose or I₀/I at 100% O₂. The glucose results are scaled to the actual concentration on GOx in the pin-printed spot.
^{e}Results of five cycles between air-saturated buffer that contained 10 mM glucose and air-saturated buffer alone without glucose or O₂- and N₂-saturated buffer solution.
^{f}Based on the analysis of a single calibrated PPBSA after being repeatedly challenged for 12 hours with 0, 2, and 10 mM glucose solution (20% O₂) and 0, 10, and 100% O₂ saturated buffer solution (pH 7.0).
^{g}Based on the analysis of a single calibrated PPBSA after being repeatedly challenged with 0, 2, and 10 mM glucose solution (20% O₂) and 0, 10, and 100% O₂ saturated buffer solution (pH 7.0) following full shutdown, weekly PPBSA recalibration, and reuse for 6 weeks.
^{h}Based on the response profiles of five separate PPBSAs fabricated at 2-3-week intervals over the course of 2.5 months using separate reagent batches and preparations following complete PPBSA calibration.

The response time and detection limits for the O₂-responsive pin-printed spot were 10-12 s and 0.1% O₂, respectively. The rapid response time and reproducibility of the detection of O₂ when the sample was cycled between O₂ and N₂ saturated buffer demonstrates the reversibility of the interaction between the analyte and chemical sensors of the PPBSAs. These results also demonstrate that the GOx-doped xerogel-based overlayer, regardless of its composition, does not affect the performance of the underlying O₂-responsive pin-printed spots. The response time for the glucose-responsive pin-printed spots is generally a factor of 3-4 greater in comparison to the O₂-responsive pin-printed spots, and the best-case response times are seen with the entirely pin-printed glucose sensors (i.e., PPBSA 2 and PPBSA 4). The 3-4-fold slower response is likely due to differences in the O₂ versus glucose diffusivity in water. The 25% difference in response time between PPBSA ⅓ and PPBSA 2/4 is consistent with differences in the actual xerogel composition (PPBSA ⅓ contain Pluronic molecules, P104, and were formed using PBS buffer; PPBSA 2/4 contain sorbital, poly(ethylene glycol) (PEG), and were formed using Tris buffer). (Note: The thickness of the glucose-responsive elements proper in PPBSA ⅓ and PPBSA 2/4 are 0.5 and 1.0 μm, respectively). The detection limits for glucose were between 0.1 and 0.2 mM. Detection limits for all four PPBSAs exceed clinical needs.

The response of the glucose-responsive pin-printed spots (scaled to the actual amount of GOx within each pin-printed spot) was a function of the xerogel composition.

When sets of PPBSAs were operated and rapidly cycled between 0 and 10 mM glucose and N₂- and O₂-saturated buffer, responses that were reproducible to within 5-7% were observed. As discussed above, these data demonstrate the reversibility of the interaction between the analytes and chemical sensors of the PBBSAs. When calibrated PPBSAs were operated over a 12-h period with regular cycling between 0, 2, and 10 mM glucose solutions (20% O₂) and 0, 10, and 100% O₂-saturated buffer solutions, the array response deviated by 3-5%. When individual PPBSAs were removed from the testing system, stored, remounted in the system, and recalibrated on a weekly basis for 6 weeks using one randomly selected biosensor-based pin-printed spot in the array, the biosensor-based pin-printed spot response deviated by no more than 4-8%. Five PPBSAs were prepared at 2-3-week intervals using different reagent batches. The pin-printed spot responses were reproducible to within 8-12%.

The reversible nature of the interaction between an analyte and chemical sensor is demonstrated by the data presented in Example 1. The rapid response times—seconds regime—for the cycling experiments are shown in Tables 1-4 and also demonstrate the reversibility of the interaction between analytes and chemical sensors used in the present method of detecting those analytes. If there was an irreversible interaction between, for example, the analyte and chemical sensor, additional treatment of the chemical sensor would likely be required to achieve these response times and reproducibilities. Treatments, such a changes in temperature, pressure, or solvent environment (e.g., a change in salt concentration of a buffer solvent), would likely be required to disengage/dissociate the analyte from the chemical sensor if there was an irreversible (kinetic/thermodynamic) interaction between the analyte and chemical sensor. Without such treatment it is unlikely such rapid response times and outstanding reproducibility on cycling would be achieved in the case of irreversible association.

### EXAMPLE 2

### Preparation of the Sol-Gel Derived Stock Solution

An “A” stock solution was prepared by mixing TEOS (3.345 mL, 15 mmole), distilled-deionozed water (0.54 mL, 30 mmole), EtOH(1.75 mL, 30 mmole), and HCl (15 μL of 0.1 M HCl, 15×10-4 mmole). This mixture was allowed to hydrolyze under ambient conditions for 2 hrs with stirring. A “B” stock solution was prepared by mixing Pro-TriMOS (0.5 mL, 2.84 mmole), TMOS(0.5 mL, 3.40 mmole), EtOH(1.2 mL, 20.6 mmole), and HCl (0.4 mL of 0.1 N HCl, 0.4×10⁻⁴ mmole). This mixture was hydrolyzed for 1 hr with stirring under ambient conditions.

### EXAMPLE 3

### Solutions Used to Form the PPCSA Pin-Printed Spots

The pin-printed spots that make up the PPCSAs were formed by doping and printing the A or B stock solutions of Example 2. A gas phase, O₂-responsive PPCSA was formed by mixing 3 μL of 34.2 mM [Ru(dpp)₃]²⁺ (dissolved in EtOH) with 500 μL of the B sol-gel stock solution of Example 2. A pH-sensitive PPCSA was formed by mixing 80 μL of 0.32 mM fluorescein-labeled dextran (dissolved in water) with 500 μL of the A sol-gel stock solution of Example 2. The O₂-responsive pin-printed spot for the dual-analyte PPCSA was formed by mixing 1.5 μL of 22.5 mM [Ru(dpp)₃]²⁺ (dissolved in EtOH) with 500 μL of the A sol-gel stock solution of Example 2.

### EXAMPLE 4

### PPCSA Fabrication

The sol-gel solutions of Example 2 were printed onto clean, glass microscope slides. Individual microscope slides were cleaned by soaking them in 1 M NaOH for 4 hrs. The slides were subsequently rinsed with copious amounts of distilled deionized water and dried at 80° C. The fluorophore-doped sol-gel processing solutions were printed directly onto the clean, glass microscope slides by using a ProSys 5510 system, available from Cartesian Technologies, Inc. of Irving, Calif., with a single model SMP-3 pin (TeleChem of Sunnyvale, Calif.). The print chamber relative humidity was maintained between 30 and 40%. The individual xerogel-based pin-printed spots were applied to the substrate on the order of 100-150 μm in diameter and were reproducible within a given PPCSA to ±10 μm. Scanning electron microscopy showed that the xerogel pin-printed spots were about 1-2 μm thick depending on the exact solution printed, the pin-to-substrate contact time, and the substrate's surface chemistry.

The pH- and O₂-responsive PPCSAs were pin printed with spot-to-spot center spacing equal to about 200 μm. Dual-analyte PPCSAs were prepared by printing alternating columns of O₂- and pH-responsive pin-printed spots with the column-to-column center spacing adjusted to about 300 μm and the row-to-row center spacing set at about 200 μm. The time required to pin print each spot was ˜1 s.

All PPCSAs were aged under ambient conditions in the dark for at least 4 days to ensure that the xerogel was fully formed prior to being tested.

### EXAMPLE 5

### Preparation of the Sol-Gel Derived Solutions for PPOSAILS Fabrication

The solution that was used to make the actual pin-printed spots was prepared by mixing 50 μL of 22.5 mM [Ru(dpp)₃]²⁺ (dissolved in EtOH) with 500 μL of the B stock solution of Example 2. A xerogel base layer was used to overcoat some LEDs. This layer is prepared by using the B stock solution of Example 2.

### EXAMPLE 6

### PPOSAILS Fabrication

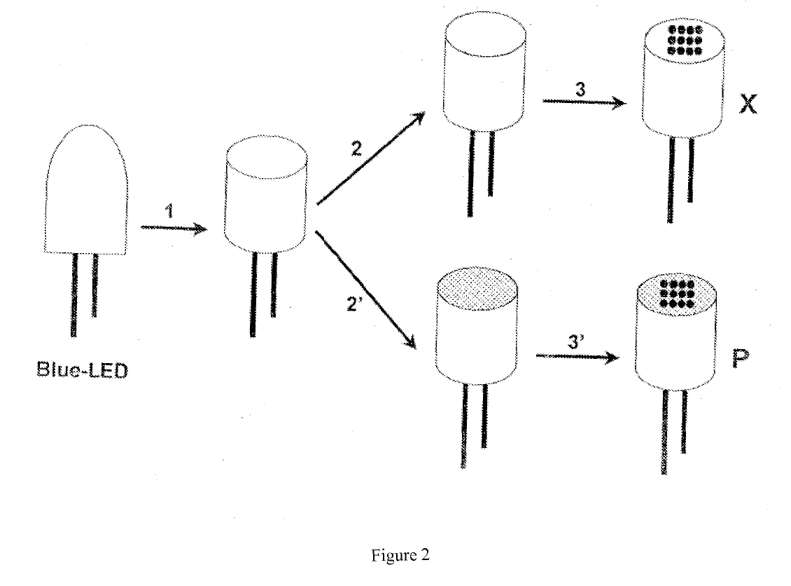

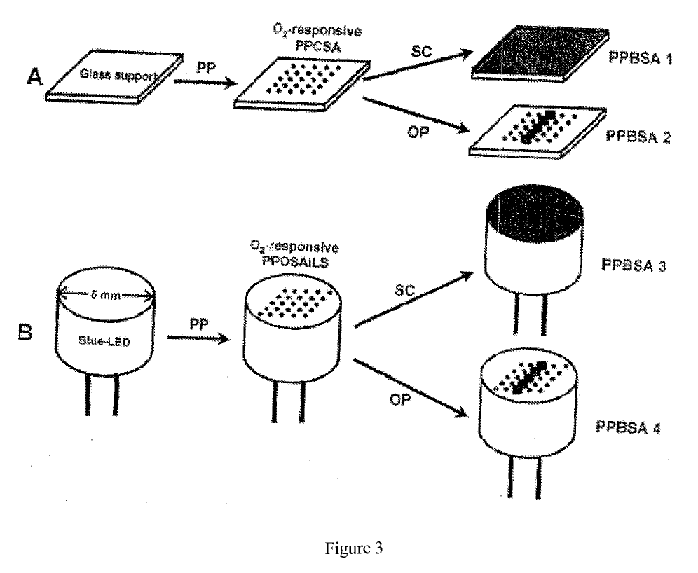

PPOSAILS were formed by following one of two divergent three-step processes (FIG. 2). In the first step (1) the LED NSPB520S was mounted in a machinists end mill and the dome-like protective portion was removed to form a planar surface. (LEDs without the rounded envelop may be used; however, the optical output from these LEDs proved inferior in comparison to a modified LED NSPB520S.) In step (2) a thin xerogel buffer layer was deposited onto the LED face to smooth out any roughness left by the end mill and to improve the adhesion between the xerogel-based pin-printed spots and the LED. Toward this end, an LED was mounted in the rotor of a spin coater with the planar surface facing up, the rotor was engaged, and the rotational velocity adjusted to 3000 rpm. A 10 μL aliquot of the B stock solution of Example 2 was then delivered to the center of the rotating LED by using a micropipette and spinning was continued for 30-40 s. The xerogel buffer layer was allowed to age for 24 hrs under ambient conditions. The buffer layer final thickness was 1.1±0.1 μm. In step 2′ two coats of blue paint (Gloss, No. 1922, available from Rust-oleum® of Vernon Hills, Ill.) was sprayed onto the LED face as a buffer layer. The final thickness of this buffer layer was 120±15 μm. In the final step (3 or 3′, FIG. 3) a ProSys 5510 system (Cartesian Technologies of Irvine, Calif.) with a single model SMP-3 pin (TeleChem of Sunnyvale, Calif.) was used to print the luminophore-doped sol-gel processing solutions directly onto the xerogel base film buffer layer (3) or the paint buffer layer (3′). During the actual printing process, relative humidity within the print chamber was 35±5%. The time required to print each pin-printed spot was ˜1 s. PPOSAILS with the xerogel or paint sub-layers are referred to as X- or P-types, respectively.

All PPOSAILS were aged under ambient conditions in the dark for at least 4 days to allow the xerogels to form.

### EXAMPLE 7

### Instrumentation

The PPOSAILS, powered by a low voltage DC power source, was mounted in a home-built flow cell holder that was positioned at the focal point of an inverted fluorescence microscope. The [Ru(dpp)₃]²⁺ molecules within the xerogel-based pin-printed spots are excited by the LED optical output and the resulting luminescence is collected by a 4× microscope objective, passed through a longpass optical filter (λ_{cutoff}=565 nm), and imaged on to the face of a thermoelectrically-cooled charge coupled device (CCD). When the PPOSAILS is driven at 5 V, the CCD integration time is ≦0.5 s.

All measurements were performed at room temperature. Sample introduction to the PPOSAILS was carried out by using a home-built gas handling system. The gas system used two separate inlets that are controlled by individual flow meters. Each inlet was connected to regulated N₂ or O₂ gas cylinders.

### EXAMPLE 8

### PPBSA Stock Sol-Gel Processing Solutions

Stock solution “D” was prepared by physically mixing 0.5 mL of N-propyltrimethoxysilane (Pro-TriMOS) (2.84 mmol), 0.5 mL of tetramethoxysilane (TMOS) (3.40 mmol), 1.2 mL of EtOH (20.6 mmol), and 0.4 mL of 0.1 N HCl (40 μmol). This mixture was hydrolyzed for 1 hour with stirring under ambient conditions. Stock solution “E” was prepared by physically mixing 2.25 mL of tetramethoxysilane (TMOS) (10.1 mmol), 0.7 mL of water (38.9 mmol), and 50 μL of 0.1 N HCl (5 μmol). This mixture was then sonicated (Model 75HT, VWR Scientific Products of West Chester, Pa.) under ambient conditions until the solution became clear (˜1 h). Stock solution “F” was prepared by adding 0.50 g of a Pluronic® P104 solution available form BASF of Mount Olive, N.J. (13.6% (w/v) dissolved in deionized water) to 1.00 g of solution E followed by stirring under ambient conditions for 30 min.

PEG, sorbital, and P104 are used to help produce crack-free, GOx-doped xerogels with active enzyme. We also had to contend with the issue of buffering the enzyme within the sol-gel processing solution and simultaneously avoiding gelling within the pin printer's quill pins. A wide variety of xerogel formulations and compositions were tested and screened to yield a combination of adequate working times prior to gelation, high GOx activity, pin-printed spot uniformity, and pin-printed spot stability. The selection of particular xerogel formulations and compositions for a particular pin-printed spot application is within the purview of one skilled in the art.

### EXAMPLE 9

### PPBSA Fabrication

FIG. 3 presents a simplified schematic describing the four types of biosensor arrays we have fabricated. Parts A and B of FIG. 3 outline the methods of producing PPBSAs onto glass microscope slides and LEDs, respectively. The basic fabrication steps include pin printing the O₂-sensing layer (PP) and forming a glucose-sensing layer or element by spin coating (SC) or overprinting (OP), respectively.

(A) Fabrication of PPBSAs onto Planar Glass Substrates.

As shown in FIG. 3A, we initially prepared an O₂-responsive PPCSA. The O₂-sensing elements are formed from a sol-gel processing solution that is composed of 4 μL of 25.0 mM [Ru(dpp)₃]²⁺ (dissolved in EtOH) and 50 μL of solution D of Example 8. All O₂-responsive PPCSAs were aged in the dark under ambient conditions for at least 4 hours before further use. In the second step, a GOx-doped sol-gel processing solution was either spin coated (SC, PPBSA 1) or overprinted (OP, PPBSA 2) on top of the O₂-responsive PPCSAs.

To prepare the glucose-responsive layer on PPBSA 1, we prepared a GOx-doped sol-gel processing solution by mixing 10 μL of a GOx stock solution (6 mg of GOx dissolved in 500 μL of PBS) with 30 μL of solution F from Example 8. An O₂-responsive PPCSA was mounted in the rotor of a spin coater with the O₂-responsive sensing elements facing up, the rotor was engaged, and the rotational velocity was adjusted to 2000 rpm. A 10-μL aliquot of the GOx-doped sol-gel processing solution was delivered to the center of the PPCSA by using a micropipet, and spinning was continued for 10 s. Profilometry showed that the GOx-doped xerogel film was 0.5±0.1 μm thick.

To prepare PPBSA 2, we mixed the 100 μL of a GOx stock solution (6 mg of GOx, 25 mg of sorbitol, and 15 mg of PEG 400 in 500 μL of Tris buffer (5 mM, pH 7.4) with 100 μL of solution E from Example 8. The GOx-doped sol-gel processing solution was printed directly on top of the PPCSAs O₂-responsive pin-printed spots. Scanning electron microscopy showed that the printed glucose-responsive sensing element were 1.0±0.1 μm thick.

Fabrication of PPBSAs onto LEDs.

FIG. 3B illustrates the procedure used to form PPBSAs on LEDs. An O₂-responsive PPOSAILS was formed first. The glucose-responsive pin-printed spots were formed by spin coating (SC, PPBSA 3) or overprinting (OP, PPBSA 4) by using the same strategies and formulations described for PPBSA 1 and PPBSA 2, respectively.

All PPBSAs were aged in the dark for at least 24 h prior to being tested. All measurements were preformed at room temperature. All experiments were performed on at least three separate occasions using separate reagent batches. Average results from all experiments are reported along with the corresponding standard deviations.

What is claimed is:

1) A method for high-throughput continuous detection of one or more analytes in a plurality of test samples comprising the steps of:
a) providing a device comprising:
i) a substrate;
ii) an array of pin-printed spots printed on the substrate, each pin-printed spot having a holding material and chemical sensor sequestered within the holding material, wherein the holding material is a sol-gel derived glass;
iii) a detector for continuously recording a signal comprising emitted light from each pin-printed spot;
b) contacting the array with one or more samples containing one or more analytes;
c) irradiating the array with an electromagnetic radiation of 200 to 900 nm; and
d) detecting the signal from each pin-printed spot as a function of time.

2) The method of claim 1, wherein at least two pin-printed spots in the array have different chemical sensors.

3) The method of claim 1, wherein the pin-printed spots are printed on the substrate using a using a sol-gel processing comprising tetraethoxysilane, trimethoxysilane, n-propyltrimethoxysilane or combinations thereof.

4) The method of claim 1, wherein the sol-gel-derived glass is xerogel.

5) The method of claim 1, wherein the sol-gel-derived glass is doped with a polymer.

6) The method of claim 5, wherein the polymer an organic polymer selected from the group consisting of polyethylene glycol and Pluronic P104 and combinations thereof.

7) The method of claim 1, wherein the step of irradiating the array is carried out by an electromagnetic radiation generator integrated within the device.

8) The method of claim 7, wherein the device is a light-emitting diode.

9) The method of claim 1, wherein the chemical sensor is selected from the group consisting of Ru[(4,7-diphenyl-1,10-phenanthroline)₃]²⁺, fluorescein-linked dextran, and glucose oxidase.

10) The method of claim 1, wherein the analyte is selected from the group consisting of O₂, glucose, protons and combinations thereof.

11) The method of claim 10, wherein the O₂ is in the gas phase.

12) The method of claim 10, wherein the O₂ is in solution.

13) The method of claim 10, wherein glucose is in solution.

14) The method of claim 10, wherein protons are in solution.

15) The method of claim 1, wherein the sample is in the form of an aerosol.

16) The method of claim 15, wherein the analyte in the sample is glucose.

17) The method of claim 1, wherein the analyte can be continuously detected for a period of at least 3 hours.

18) The method of claim 1, wherein the analyte can be continuously detected for a period of at least 42 days.

19) The method of claim 1, wherein the analyte can be continuously detected for a period of at least 18 months.
